(19) United States
(12) Patent Application Publication
(10) Pub. No.: US 2019/0337236 A1
(43) Pub. Date: Nov. 7, 2019

(54) Plastic Containing Assembly Having Filler Material Arrangement for Welding

(71) Applicant: Zhuhai Ding Rong Plastic Products CO., LTD, Zhuhai (CN)

(72) Inventor: Ting Nan Liu, New Taipei city (TW)

(21) Appl. No.: 15/968,876

(22) Filed: May 2, 2018

(51) Int. Cl. B29C 65/08; B29C 65/00; B65D 6/00

(52) U.S. Cl. CPC B29C 65/08; B29C 66/5221; B29L 2031/712; B29C 66/712; B65D 11/10; B29C 66/8322

(57) ABSTRACT

A plastic containing assembly is provided with a container including a containing member, a front reduced section formed with the containing member, and a shoulder between a front end of the containing member and the reduced section; and a hollow, externally threaded adaptor including an outer protrusion put on the reduced section, an inner projection inserted into both the front end of the containing member and the reduced section, a groove on an outer surface of the projection, a filler member between the groove and the protrusion, and an axial passage communicating with an open front end of the adaptor and the projection respectively. An ultrasonic welding machine may apply high-frequency ultrasonic acoustic vibrations to the filler member and melt same to join the shoulder, thereby forming a first joining layer; and melt a joining portion of the reduced section and the protrusion, thereby forming a second joining layer.

### BACKGROUND OF THE INVENTION

### 1. Field of the Invention

The invention relates to welding and more particularly to a plastic containing assembly having filler material arrangement, an ultrasonic welding machine applying high-frequency ultrasonic acoustic vibrations to the filler material at each point of a container and an adaptor to form first, second and third joining layers and further enhance strength and sealing capability of the produced plastic containing assembly.

### 2. Description of Related Art

Welding is a fabrication process that joins materials such as thermoplastics by causing fusion. Welding is irreversible. Welding is typically done to permanently fasten two or more components together. Welding has advantages of being applicable to mass production, quality, low production cost, etc.

An ultrasonic welding machine may apply high-frequency ultrasonic acoustic vibrations to melt filler material on workpieces being held together under pressure to create a solid-state weld after being cooled. It is commonly used for plastics, and especially for joining dissimilar plastic materials. Regarding applying pressure in the ultrasonic welding, an air compressor and an air tank are typically provided with the ultrasonic welding machine. High air pressure is applied to points of the workpieces to be joined. Further, high air pressure is applied to cool the welds in the final step. Otherwise, the welds may be failed.

Conventionally, the ultrasonic welding machine is used to apply high-frequency ultrasonic acoustic vibrations to melt filler material of a component made of ABS (acrylonitrile butadiene styrene) and another component made of AS or PCTG (poly-cyclohexylenedimethylene terephthalate glycol-modified) being held together under pressure to create a solid-state weld after being cooled. However, filler material is added to only point and thus the created weld by the conventional ultrasonic welding machine is not robust and even fails. This is particularly true for plastics (e.g., PET (polyethylene terephthalate), PETG (polyethylene terephthalate glycol-modified), or PP (polypropelene) which are difficult of being joined by welding. As such, the produced product (e.g., a plastic container) may suffer leak in use.

Thus, the need for improvement still exists.

### SUMMARY OF THE INVENTION

It is therefore one object of the invention to provide a plastic containing assembly comprising a container including a containing member having an internal space, a front reduced section formed with the containing member, and a shoulder between a front end of the containing member and the reduced section; and a hollow, externally threaded adaptor including an outer protrusion configured to put on the reduced section, an inner projection adapted to insert into both the front end of the containing member and the reduced section, a groove on an outer surface of the projection, a filler member between the groove and the protrusion, and an axial passage communicating with an open front end of the adaptor and the projection respectively; wherein an ultrasonic welding machine applies high-frequency ultrasonic acoustic vibrations to the filler member and melts same to join the shoulder, thereby forming a first joining layer; and wherein the ultrasonic welding machine applies high-frequency ultrasonic acoustic vibrations to melt a joining portion of the reduced section and the protrusion, thereby forming a second joining layer.

Preferably, the filler member includes at least one filler material elements of triangular section.

Preferably, the ultrasonic welding machine applies high-frequency ultrasonic acoustic vibrations to melt a joining portion of the front end of the containing member and the groove, thereby forming a third joining layer.

Preferably, a melting point of the container is different from that of the adaptor.

Preferably, a melting point of the container is the same as that of the adaptor.

The invention has the following advantages and benefits in comparison with the conventional art: by utilizing the multi-welding point technique and causing the ultrasonic welding machine to apply high-frequency ultrasonic acoustic vibrations to the filler material at each of a plurality of points of the container and the adaptor which are made of dissimilar materials, a first joining layer, a second joining layer and a third joining layer are formed to enhance strength of the joining portions of the container and the adaptor. Thus, the manufactured plastic containing assembly has an increased capability of withstanding strong collision. Contents in the plastic containing assembly are prevented from being spilled out of the joining portions of the container and the adaptor.

The above and other objects, features and advantages of the invention will become apparent from the following detailed description taken with the accompanying drawings.

### BRIEF DESCRIPTION OF THE DRAWINGS

FIG. 1 is a perspective, exploded view of a plastic containing assembly having filler material arrangement for welding according to the invention;

FIG. 2 is a longitudinal sectional view of the assembled container and adaptor of the plastic containing assembly prior to welding;

FIG. 2A is an enlarged detailed view of the area A shown in FIG. 2;

FIG. 3 is a view similar to FIG. 2 but after the welding;

FIG. 3A is an enlarged detailed view of the area A shown in FIG. 3; and

FIG. 4 schematically depicts a fabrication process of the plastic containing assembly in cooperation with an ultrasonic welding machine.

### DETAILED DESCRIPTION OF THE INVENTION

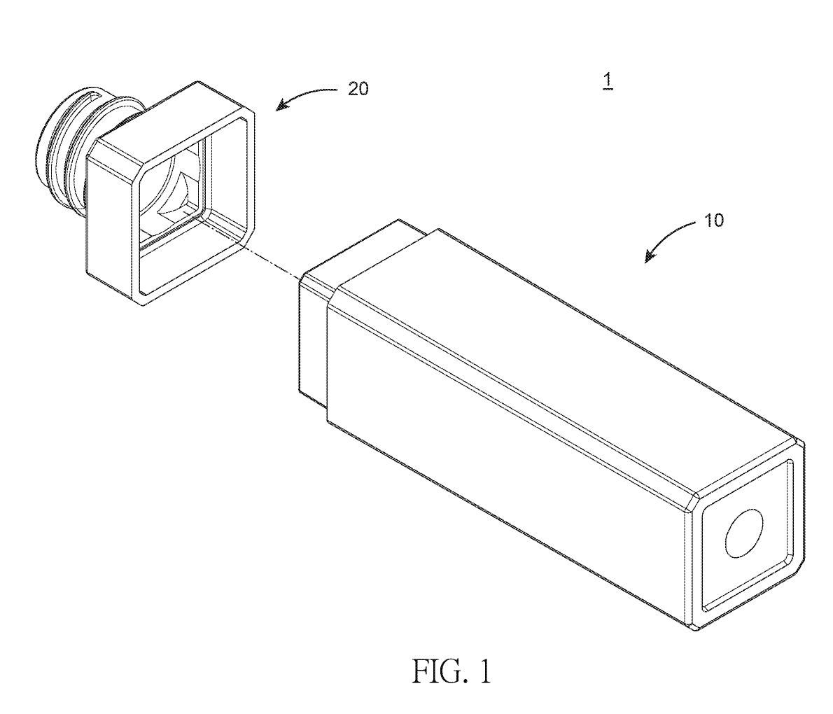

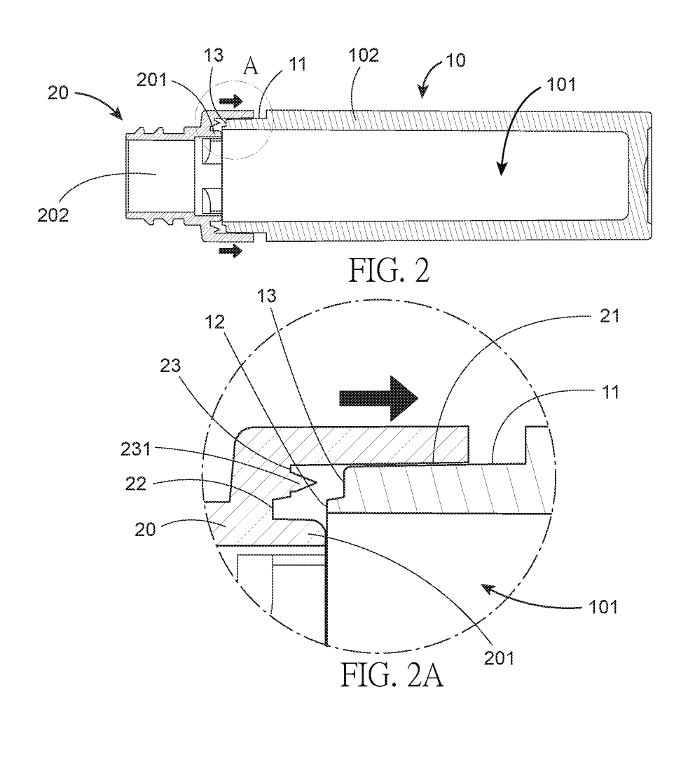

Referring to FIGS. 1 to 4, a plastic containing assembly 1 having a filler material arrangement for welding in accordance with the invention comprises the following components as discussed in detail below.

A container 10 has a rectangular section and includes an internal space 101, a containing member 102 surrounding the space 101 and having a front reduced section 11, and a shoulder 13 between a front end 12 and the reduced section 11.

A hollow, externally threaded adaptor 20 includes an outer, rectangular protrusion 21 configured to put on the reduced section 11, an inner, rectangular projection 201 configured to insert into both the front end 12 and the reduced section 11, a rectangular groove 22 on an outer surface of the projection 201, a filler member 23 formed between the groove 22 and the protrusion 21 and having a plurality of projecting filler material elements 231 of triangular section, and an axial passage 202 communicating with an open front end of the adaptor 20 and the projection 201 respectively.

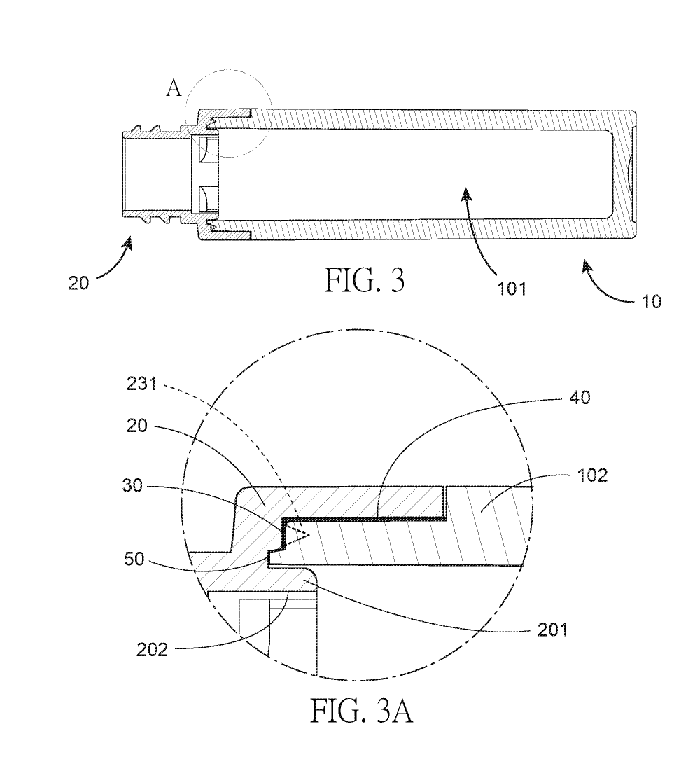

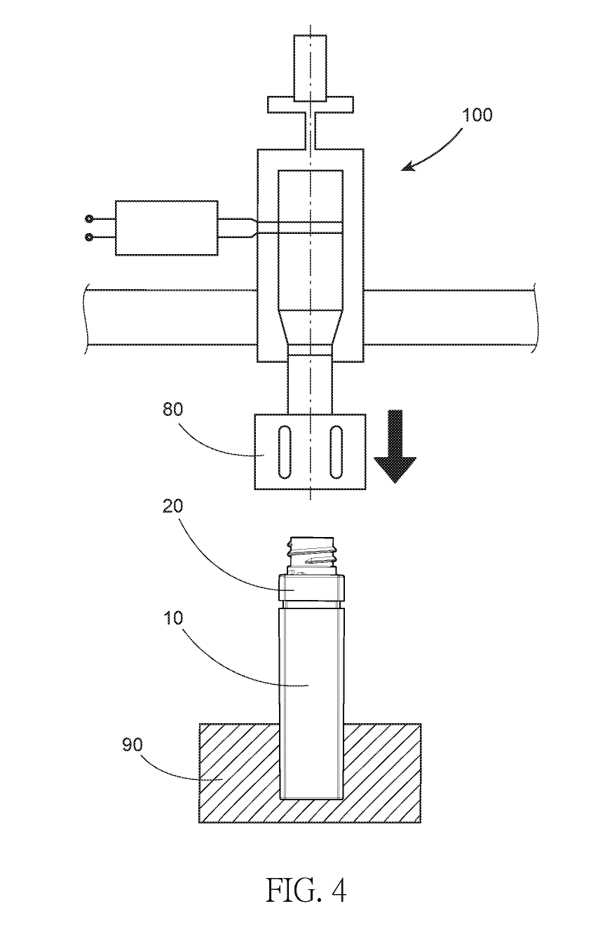

As shown in FIGS. 3, 3A and 4 specifically, the container 10 is provided in a lower mold 90, and the adaptor 20 is provided in an upper mold 80 respectively. The upper mold 80 moves downward to push the adaptor 20 toward the container 10. Then an ultrasonic welding machine 100 applies high-frequency ultrasonic acoustic vibrations to the projecting filler material elements 231. And in turn, the projecting filler material elements 231 are melted to join the shoulder 13, thereby forming a first joining layer 30. Also, a joining portion of the reduced section 11 and the protrusion 21 is melted to form a second joining layer 40. Still also, a joining portion of the front end 12 and the groove 20 is melted to form a third joining layer 50. As a result, the adaptor 20 and the container 10 are joined.

It is envisaged by the invention that the container 10 may have a section other than rectangle, and the adaptor 20 may have complimentary section in other embodiments.

In a first embodiment of the invention, both the container 10 and the adaptor 20 are made of dissimilar plastics having different melding points. By utilizing the multi-welding point technique of the invention, the ultrasonic welding machine 100 applies high-frequency ultrasonic acoustic vibrations to the filler material at each of a plurality of points of the container 10 and the adaptor 20. The filler material is melted to join the container 10 and the adaptor 20 at the point. As a result, the container 10 and the adaptor 20 are joined.

The dissimilar plastics having different melting points are PET (polyethylene terephthalate), PETG (polyethylene terephthalate glycol-modified), and PP (polypropelene) which are difficult of being joined and are adapted to join with ABS (acrylonitrile butadiene styrene).

In a second embodiment of the invention, both the container 10 and the adaptor 20 are made of dissimilar plastics having the same melding points. By utilizing the multi-welding point technique of the invention, the ultrasonic welding machine 100 applies high-frequency ultrasonic acoustic vibrations to the filler material at each of a plurality of points of the container 10 and the adaptor 20. The filler material is melted to join the container 10 and the adaptor 20 at the point. As a result, the container 10 and the adaptor 20 are joined.

The dissimilar plastics having the same melting points are AS and PCTG (poly-cyclohexylenedimethylene terephthalate glycol-modified) which are easy of being joined and are adapted to join with ABS (acrylonitrile butadiene styrene).

In view of above discussion, the invention has the following characteristics and advantages: by utilizing the multi-welding point technique of the invention and causing the ultrasonic welding machine 100 to apply high-frequency ultrasonic acoustic vibrations to the filler material at each of a plurality of points of the container 10 and the adaptor 20 which are made of dissimilar materials, a first joining layer 30, a second joining layer 40 and a third joining layer 50 are formed to enhance strength of the joining portions of the container 10 and the adaptor 20. Thus, the manufactured plastic containing assembly 1 has an increased capability of withstanding strong collision. Contents in the plastic containing assembly 1 are prevented from being spilled out of the joining portions of the container 10 and the adaptor 20. In brief, the plastic containing assembly 1 has the advantages of being good in withstanding collision, being resistant to high pressure, and being cost effective.

While the invention has been described in terms of preferred embodiments, those skilled in the art will recognize that the invention can be practiced with modifications within the spirit and scope of the appended claims.

What is claimed is:

1. A plastic containing assembly comprising:
a container including a containing member having an internal space, a front reduced section formed with the containing member, and a shoulder between a front end of the containing member and the reduced section; and
a hollow, externally threaded adaptor including an outer protrusion configured to put on the reduced section, an inner projection adapted to insert into both the front end of the containing member and the reduced section, a groove on an outer surface of the projection, a filler member between the groove and the protrusion, and an axial passage communicating with an open front end of the adaptor and the projection respectively;
wherein an ultrasonic welding machine applies high-frequency ultrasonic acoustic vibrations to the filler member and melts same to join the shoulder, thereby forming a first joining layer; and
wherein the ultrasonic welding machine applies high-frequency ultrasonic acoustic vibrations to melt a joining portion of the reduced section and the protrusion, thereby forming a second joining layer.

2. The plastic containing assembly of claim 1, wherein the filler member includes at least one projecting filler material element of triangular section.

3. The plastic containing assembly of claim 1, wherein the ultrasonic welding machine applies high-frequency ultrasonic acoustic vibrations to melt a joining portion of the front end of the containing member and the groove, thereby forming a third joining layer.

4. The plastic containing assembly of claim 1, wherein a melting point of the container is different from that of the adaptor.

5. The plastic containing assembly of claim 1, wherein a melting point of the container is the same as that of the adaptor.
